(19) United States
(12) Patent Application Publication
(10) Pub. No.: US 2016/0188186 A1
(43) Pub. Date: Jun. 30, 2016

(54) ELECTRONIC DEVICE AND METHOD FOR DISPLAYING INFORMATION USING THE ELECTRONIC DEVICE

(71) Applicant: FIH (HONG KONG) LIMITED, Kowloon (HK)

(72) Inventor: WANG-HUNG YEH, New Taipei (TW)

(21) Appl. No.: 14/691,227

(22) Filed: Apr. 20, 2015

(30) Foreign Application Priority Data
Dec. 30, 2014 (TW) 103146303

(51) Int. Cl. G06F 3/0484; G06F 3/0488

(52) U.S. Cl. CPC G06F 3/04847; G06F 3/04883

(57) ABSTRACT

In a method for displaying information on a touch screen of an electronic device, instructions are received to preset a sliding operation performable on the touch screen. Instructions are received to preset an informational interface displayable on the touch screen when the preset sliding operation is performed. A first preset sliding operation performed on the touch screen by a user is detected; The preset informational interface is displayed on a portion of the touch screen when the first preset sliding operation is detected; A second preset sliding operation performed on the touch screen by a user is detected; and the preset informational interface is adjusted to display on the full touch screen.

### CROSS-REFERENCE TO RELATED APPLICATIONS

This application claims priority to Taiwanese Patent Application No. 103146303 filed on Dec. 30, 2014, the contents of which are incorporated by reference herein.

### FIELD

The subject matter herein generally relates to touch-sensitive displays, and more particularly to displaying information on a touch screen of an electronic device.

### BACKGROUND

An electronic device, such as a mobile phone or a personal digital assistant (PDA), usually receives information pushed by applications of the electronic device. However, when an information interface including the information is displayed on a touch screen of the electronic device, the information interface covers all of the display area of the touch screen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device including an information display system.

FIG. 2 is a block diagram of an example embodiment of function modules of the information display system in FIG. 1.

FIG. 3 is a flowchart of an example embodiment of a method for displaying information using the electronic device in FIG. 1.

FIG. 4 illustrates a diagrammatic view of an example embodiment of a sliding operation and an information interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

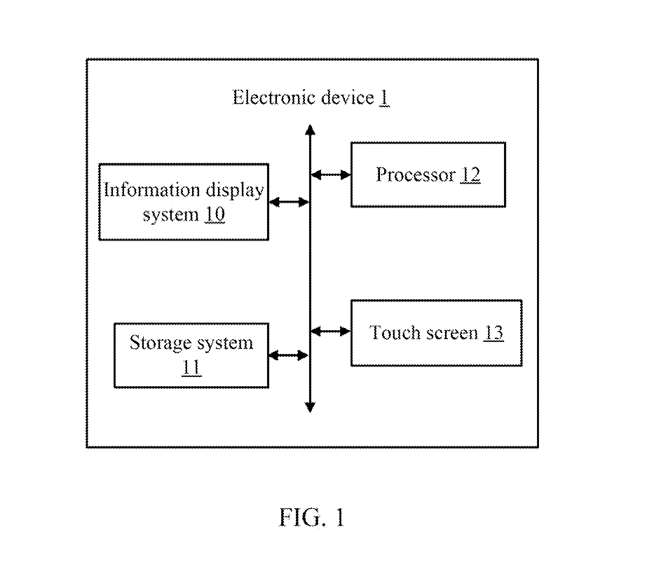

FIG. 1 is a block diagram of an example embodiment of an electronic device including an information display system. In at least one embodiment, an electronic device 1 includes an information display system 10. The electronic device 1 can be a smart phone, a tablet computer, or a personal digital assistant (PDA), for example, which is installed with a touch screen 13. The electronic device 1 further includes, but is not limited to, a storage system 11 and at least one processor 12. FIG. 1 illustrates only one example of the electronic device that can include more or fewer components than illustrated, or have a different configuration of the various components in other embodiments.

The storage system 11 can include various types of non-transitory computer-readable storage media. For example, the storage system 11 can be an internal storage system, such as a flash memory, a random access memory (RAM) for temporary storage of information, and/or a read-only memory (ROM) for permanent storage of information. The storage system 11 can also be an external storage system, such as a hard disk, a storage card, or a data storage medium. The at least one processor 12 can be a central processing unit (CPU), a microprocessor, or other data processor chip that performs functions of the electronic device 1. The touch screen 13 can be a liquid crystal display (LCD) or an organic light-emitting diode (OLED) display. The touch screen 13 can recognize a touch location of a touch operation when touched by a finger or a stylus, and display user interfaces of applications according to the touch operation.

In at least one embodiment, the information display system 10 receives instructions to presets a sliding operation performable on the touch screen 13, and an informational interface displayable on the touch screen 13 when the preset sliding operation is performed. When a first sliding operation is performed on the touch screen 13 by a user, the information display system 10 displays the preset information interface on a portion of the touch screen which includes information pushed by applications of the electronic device 1. When a second sliding operation is performed on the touch screen 13 by the user, the information display system 10 adjust the preset informational interface to display on the full touch screen.

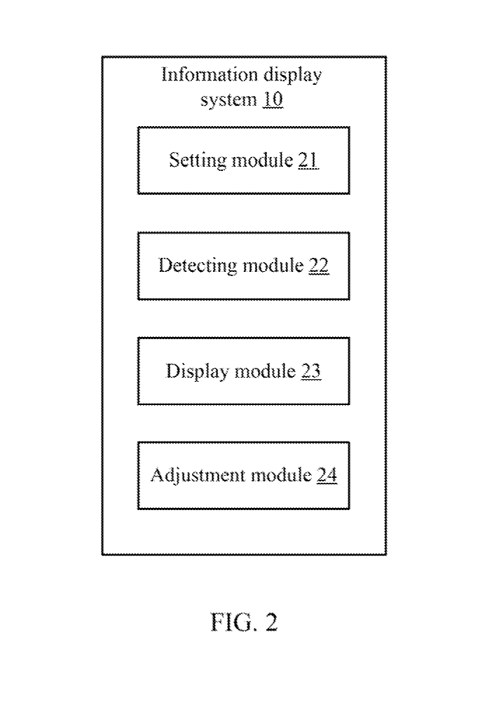

FIG. 2 is a block diagram of an example embodiment of function modules of the information display system in FIG. 1. In at least one embodiment, the information display system 10 can include a setting module 21, a detecting module 22, a display module 23, and an adjustment module 24. The function modules 21-24 can include computerized code in the form of one or more programs, which are stored in the storage system 11 and can be executed by the at least one processor 12 to provide functions of the function modules 21-24.

The setting module 21 receives instructions to preset a sliding operation performable on the touch screen, and an information interface displayable on the touch screen when the preset sliding operation is performed. In at least one embodiment, the preset sliding operation can be, but is not limited to, a touch operation sliding on the touch screen 13 from top to bottom, a touch operation sliding on the touch screen 13 from left to right, or a touch operation sliding on the touch screen 13 from right to left. The preset information interface can be set according to the sliding operation. For example, when the preset sliding operation is the touch operation sliding on the touch screen 13 from top to bottom, a display location of the preset information interface can be a top area of the touch screen 13, a width of the preset information interface can be ½ or ¼ or the same width of the touch screen 13, and a length of the preset information interface can be ½ or ¼ or the same length of the touch screen 13. When the preset sliding operation is the touch operation sliding on the touch screen 13 from left to right, the display location of the preset information interface can be a left area of the touch screen 13, the width of the preset information interface can be ½ or ¼ or the same width of the touch screen 13, and the length of the preset information interface can be ½ or ¼ or the same length of the touch screen 13. When the preset sliding operation is the touch operation sliding on the touch screen 13 from right to left, the display area of the preset information interface can be a right area of the touch screen 13, the width of the preset information interface can be ½ or ¼ or the same width of the touch screen 13, and the length of the preset information interface can be ½ or ¼ or the same length of the touch screen 13.

The detecting module 22 detects a first preset sliding operation when performed on the touch screen 13 by a user according to touch signals received.

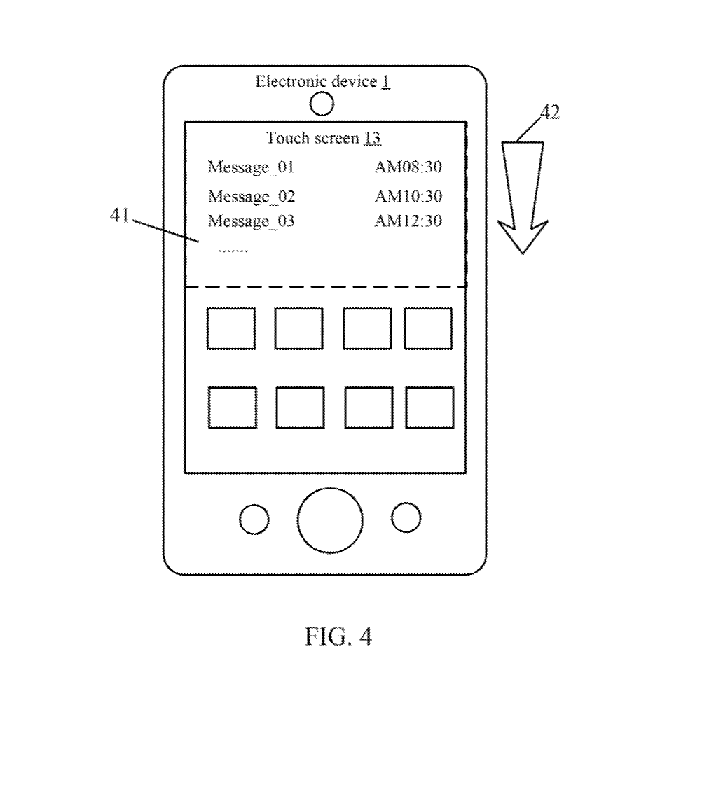

The display module 23 displays the preset information interface on a portion of the touch screen 13 according to the display area of the preset information interface, the width of the preset information interface, and the length of the preset information interface, when the first preset sliding operation is detected. As an example as shown in FIG. 4, when a preset sliding operation 42 that slides on the touch screen 13 from top to bottom is performed, an preset information interface 41 can be displayed on the touch screen 13, and a width of the preset information interface 41 is the same as the touch screen 13, a length of the preset information interface 41 is ½ of the length of touch screen 13, three messages pushed by applications of the electronic device 1 are displayed in the preset information interface 41.

The detecting module 22 detects a second preset sliding operation when performed on the touch screen 13 by the user.

The adjustment module 24 adjusts the preset informational interface to display on the full touch screen 13 when the second sliding operation is performed on the touch screen 13. As the example as shown in FIG. 4, if the preset sliding operation 42 is performed again after the preset information interface 41 has been displayed on the touch screen 13, the preset information interface 41 can be adjusted to display on the full touch screen 13.

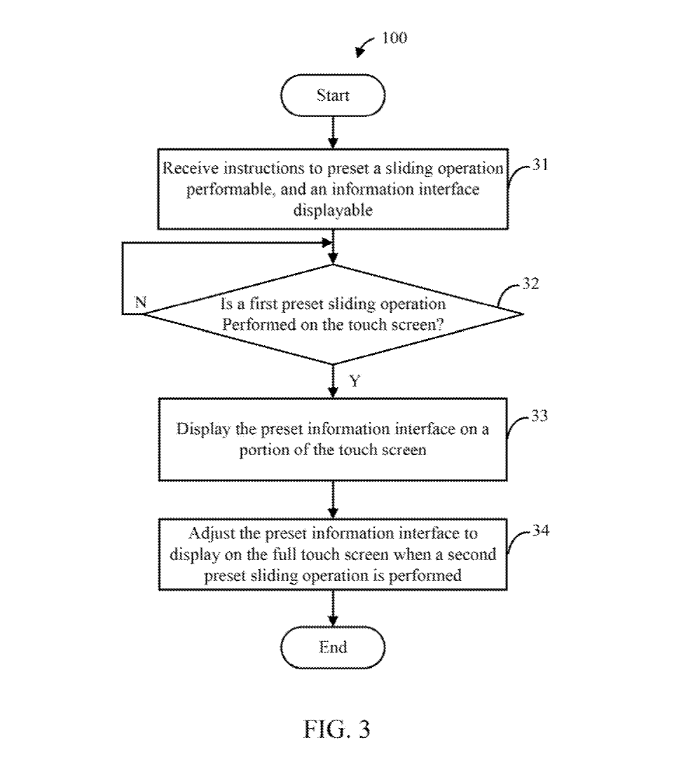

FIG. 3 illustrates a flowchart of an example embodiment of a method 100 for displaying information on a touch screen of the electronic device of FIG. 1. In at least one embodiment, the method 100 is provided by way of example, as there are a variety of ways to carry out the method. The method 100 described below can be carried out using the configurations illustrated in FIGS. 1-2, for example, and various elements of these figures are referenced in explaining example method. Each block shown in FIG. 3 represents one or more processes, methods, or subroutines, carried out in the exemplary method. Furthermore, the illustrated order of blocks is by example only and the order of the blocks can be changed. The exemplary method can begin at block 31. Depending on the embodiment, additional blocks can be added, others removed, and the ordering of the blocks can be changed.

At block 31, a setting module receives instructions to preset a sliding operation performable on the touch screen, and an information interface displayable on the touch screen when the preset sliding operation is performed. The preset sliding operation can be a touch operation sliding on the touch screen from top to bottom, a touch operation sliding on the touch screen from left to right, or a touch operation sliding on the touch screen from right to left.

At block 32, a detecting module detects a first preset sliding operation when performed on the touch screen by a user according to touch signals received. If the first preset sliding operation is performed, block 33 is implemented. If the first preset sliding operation is not performed, block 32 is repeated.

At block 33, a display module displays the preset information interface on a portion of the touch screen when the first preset sliding operation is detected.

At block 34, an adjustment module adjusts the preset information interface to display on the full touch screen when a second preset sliding operation is performed on the touch screen by the user.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for displaying information on a touch screen of an electronic device, the method comprising:
receiving instructions presetting a sliding operation performable on the touch screen;
receiving instructions presetting an informational interface displayable on the touch screen when the preset sliding operation is performed;
detecting a first preset sliding operation when performed on the touch screen by a user;
displaying the preset informational interface on a portion of the touch screen when the first preset sliding operation is detected;
detecting a second preset sliding operation when performed on the touch screen by the user; and
adjusting the preset informational interface to display on the full touch screen.

2. The method according to claim 1, wherein the preset sliding operation comprises a touch operation sliding on the touch screen from top to bottom, a touch operation sliding on the touch screen from left to right, and a touch operation sliding on the touch screen from right to left.

3. The method according to claim 1, wherein a display location of the preset information interface comprises a top display area of the touch screen, a left display area of the touch screen, and a right display area of the touch screen.

4. The method according to claim 1, wherein a width of the preset information interface is ½ or ¼ or the same width of the touch screen, and a length of the preset information interface is ½ or ¼ or the same length of the touch screen.

5. An electronic device, comprising:
a touch screen;
at least one processor; and
a storage system that stores one or more programs, when executed by the at least one processor, cause the at least one processor to:
receives instructions presetting a sliding operation performable on the touch screen;
receives instructions presetting an informational interface displayable on the touch screen when the preset sliding operation is performed;
detects a first preset sliding operation whether performed on the touch screen by a user;
displays the preset informational interface on a portion of the touch screen when the first preset sliding operation is detected;
detects a second preset sliding operation when performed on the touch screen by the user; and
adjusts the preset informational interface to display on the full touch screen.

6. The electronic device according to claim 5, wherein the preset sliding operation comprises a touch operation sliding on the touch screen from top to bottom, a touch operation sliding on the touch screen from left to right, and a touch operation sliding on the touch screen from right to left.

7. The electronic device according to claim 5, wherein a display location of the preset information interface comprises a top display area of the touch screen, a left display area of the touch screen, and a right display area of the touch screen.

8. The electronic device according to claim 5, wherein a width of the preset information interface is ½ or ¼ or the same width of the touch screen, and a length of the information interface is ½ or ¼ the same length of the touch screen.

9. A non-transitory storage medium having stored thereon instructions that, when executed by a processor of an electronic device, causes the processor to perform a method for displaying information on a touch screen of the electronic device, the method comprising:
receiving instructions presetting a sliding operation performable on the touch screen;
receiving instructions presetting an informational interface displayable on the touch screen when the preset sliding operation is performed;
detecting a first preset sliding operation whether performed on the touch screen by a user;
displaying the preset informational interface on a portion of the touch screen when the first preset sliding operation is detected;
detecting a second preset sliding operation when performed on the touch screen by the user; and
adjusting the preset informational interface to display on the full touch screen.

10. The non-transitory storage medium according to claim 9, wherein the preset sliding operation comprises a touch operation sliding on the touch screen from top to bottom, a touch operation sliding on the touch screen from left to right, and a touch operation sliding on the touch screen from right to left.

11. The non-transitory storage medium according to claim 9, wherein a display location of the preset information interface comprises a top display area of the touch screen, a left display area of the touch screen, and a right display area of the touch screen.

12. The non-transitory storage medium according to claim 9, wherein a width of the preset information interface is ½ or ¼ or the same width of the touch screen, and a length of the preset information interface is ½ or ¼ the same length of the touch screen.
